(19) United States
(12) Patent Application Publication
(10) Pub. No.: US 2022/0038752 A1
(43) Pub. Date: Feb. 3, 2022

(54) Multi-Channel Video Stream Summarization

(71) Applicant: Wang-Chan Wong, Irvine, CA (US)

(72) Inventor: Wang-Chan Wong, Irvine, CA (US)

(21) Appl. No.: 16/983,663

(22) Filed: Aug. 3, 2020

(51) Int. Cl. H04N 21/2187; G06K 9/00; H04N 21/8549; H04N 21/218; H04N 21/234; H04N 21/238; G11B 27/02

(52) U.S. Cl. CPC H04N 21/2187; G06K 9/00288; H04N 21/8549; G11B 27/02; H04N 21/234; H04N 21/238; H04N 21/21805

(57) ABSTRACT

Methods and system are provided for multi-channel video stream summarization in real time. In one novel aspect, live video streams of objects of interest are transmitted on CDN channels associated with corresponding object of interest. In one embodiment, a plurality of CDN channels is created for a plurality of corresponding objects of interest. A sensor signal is received, which associates an identified input live video stream with a monitored object of interest. The identified video stream is transmitted in real time to a corresponding CDN channel associated with the monitored object of interest. The sensor signal is electrical or any type of signal from ID markers attached to the object of interest or is based on a result of real-time image recognition. An alert is generated for a CDN channel upon detecting one or more alerting triggering events.

### TECHNICAL FIELD

The present invention relates generally to video stream and, more particularly, multi-channel video stream summarization.

### BACKGROUND

Video cameras are almost ubiquitous in modern society, especially for smart city and surveillance monitoring applications. Video streams are delivered to users/subscribers through content delivery network (CDN). Video streaming from these video cameras can be applied to many use cases other than surveillance. Today, live video stream can be used to send real-time video streams to users. The live video stream may be captured by multiple cameras and the live stream can switch among video frames captured by the multiple cameras. In some applications, multiple video streams from different cameras can be streamed to the user in real-time. The users, however, do not have control over which stream or streams to be shown in real-time. For example, there are demands to create “summaries” of individual objects in a sport event such as marathons, weddings, graduations, and other social events. The individual objects of interest may be captured by different cameras as the objects move around. Different video editing applications are developed to generate summary video streams using the recorded video streams. These applications share a common objective: they would create a summary from a video on a specific object for a specific events or triggers. The summary video is a post event edited video that captures some object of interest.

The users of these video cannot get the live summary video streams. Improvements are needed to generate real-time video streams that captures objects of interest.

### SUMMARY

Methods and system are provided for multi-channel video stream summarization in real time. In one novel aspect, live video streams of objects of interest are transmitted on CDN channels associated with corresponding object of interest. In one embodiment, the video processing system creates a plurality of CDN channels for a plurality of corresponding objects of interest, wherein each CDN channel has a unique CDN identification (ID) associated with a corresponding object of interest, and wherein each CDN channel carries an output video stream with presence of associated object of interest, receives one or more input live video streams from one or more video recording units, receives a sensor signal that associates an identified input live video stream with a monitored object of interest, and transmits in real time the identified input live video stream to an output CDN channel with a CDN ID associated with the monitored object of interest. In one embodiment, the sensor signal is sent by a sensor device upon detecting an ID signal from an ID marker attached to the monitored object of interest. In another embodiment, the sensor signal is based on a result of real-time image recognition identifying the monitored object of interest in the identified input live video stream. In yet another embodiment, the video processing system generates an alert for a CDN channel upon detecting one or more alerting triggering events comprising: a sensor switching event, an object of interest out of range event, a timeout event, and an end of monitoring event. In one embodiment, the video processing system sends the alert to one or more subscribers subscribed to the CDN channel based on predefined alerting rules. In another embodiment, the video processing system adds filler frames to a CDN video stream upon detecting one or more triggering events of the corresponding object of interest. In yet another embodiment, the video processing system archives the one or more CDN video streams and performs postproduction video enhancements on the archived one or more CDN video streams.

In another novel aspect, a subscriber ID is created for the subscriber to receive a live CDN video stream of an object of interest, wherein the live CDN video stream is a real-time compilation of one or more inputs from one or more video recording units capturing the object of interest, and wherein the live CDN video stream is compiled in real time using sensor signals. A CDN channel is associated with the subscriber ID, wherein the CDN channel streams the live CDN video stream uniquely identified by a CDN ID that is associated with the object of interest. The subscriber receives the live CDN video stream associated with the subscriber ID. In one embodiment, wherein the subscriber ID is associated with a plurality of CND channels, and wherein the subscriber can receive a plurality of corresponding CDN video streams. In another embodiment, the subscriber receives an enhanced video recording for the object of interest by the subscriber, wherein the object of interest is identified by the CDN ID. The subscriber receives an alert, wherein the alert is triggered upon detecting triggering events for the corresponding CDN channel.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates exemplary diagrams of a multi-channel video stream summarization system in accordance with embodiments of the current invention.

FIG. 2 illustrates exemplary diagrams of a VPM that configures multiple CDN channels and live streams multiple video streams each associated with an object of interest in accordance with embodiments of the current invention.

FIG. 3 illustrates exemplary diagrams for a sensor control unit that generates sensor signals for the multiplexer to compile source videos from one or more input live video streams for each CDN channels in accordance with embodiments of the current invention.

FIG. 4 illustrates exemplary diagrams of the alert system in accordance with embodiments of the current invention.

FIG. 5 illustrates an exemplary diagram of a CDN video stream for a monitored object of interest in accordance with embodiments of the current invention.

FIG. 6 illustrates exemplary diagrams for CDN video file postproduction in accordance with embodiments of the current invention.

FIG. 7 illustrates an exemplary diagram for system set up for the live streaming through CDN channel in accordance with embodiments of the current invention.

FIG. 8 illustrates exemplary diagrams for subscriber management for the live streaming through CDN channel in accordance with embodiments of the current invention.

FIG. 9 illustrates an exemplary flow chart for multi-channel video stream in real time in accordance with embodiment of the current invention.

FIG. 10 illustrates an exemplary flow chart for a subscriber of the multi-channel video stream summarization system to subscribe and receives live video streams of object of interest in accordance with embodiments of the current invention.

### DETAILED DESCRIPTION

Reference will now be made in detail to some embodiments of the invention, examples of which are illustrated in the accompanying drawings.

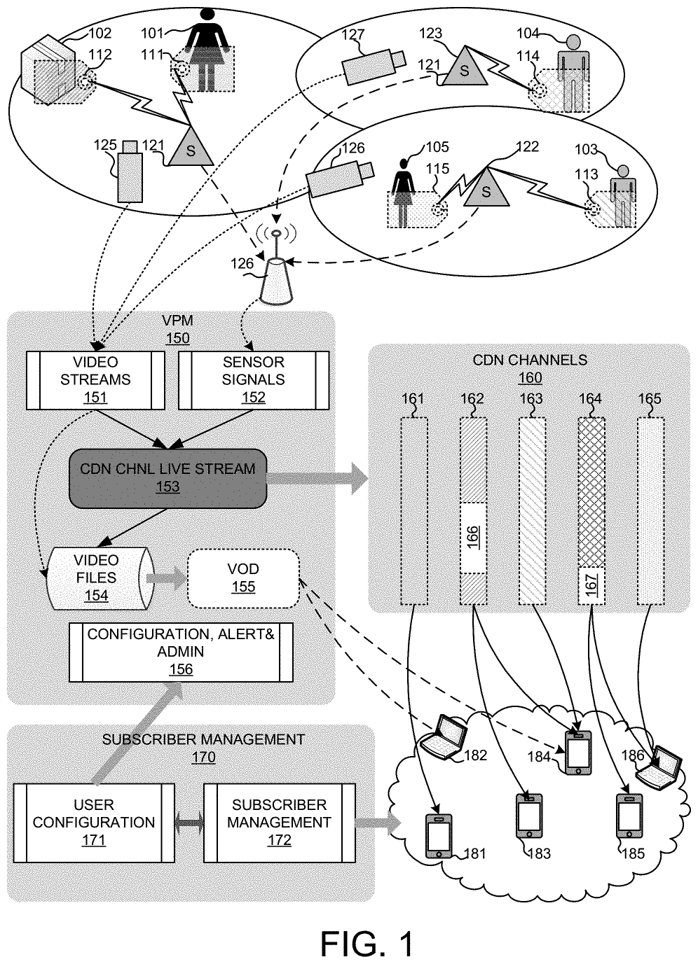

FIG. 1 illustrates exemplary diagrams of a multi-channel video stream summarization system in accordance with embodiments of the current invention. An exemplary content delivery network delivers video streams for each object of interest through corresponding CDN channel, which is uniquely identified by a CDN identification (ID). Each object of interest, such as objects 101, 102, 103, 104, and 105, is associated with a sensor, such as sensors 111, 112, 113, 114, and 115, respectively. A video process module 150 processed multiple video streams captured by multiple video recording units, such as cameras 125, 126, and 127. In one novel aspect, VPM 150 created multiple CDN channels 150 and transmits live video streams the CDN channels. VPM 150 also performs postproduction video enhancement for each live stream. Each CDN channels, such as CDN channel 161, 162, 163, 164, and 165 associated with one object of interest, such as object of interest 101, 102, 103, 104, and 105. One or more subscribers, such as subscribers 181, 182, 183, 184, 185 and 186. A subscriber management module 170 manages configuration of the subscribers and communicates with VPM 150.

The sensor can be an Internet of Thing (IoT) sensor, an RFID, or any electronic devices that can trigger the camera. For example, the object of interest may wear an IoT bracelet, an IoT tag, or an IoT badge. The sensors are connected VPM 150 via signal channels. In one embodiment, the sensor signals are sent to VPM 150 through wireless network with base stations such as 121, 122, and 123. In one embodiment, the wireless network is a Bluetooth network. In another embodiment, if the camera is always on, the camera itself becomes a sensor that applies image or facial recognition AI machine learning model to identify the object(s) of interest. In this case, there is no need for the wireless network for the signal transmission. The AI image or facial recognition software can reside in one or more cameras such as cameras 125, 126, and 127. Cameras 125, 126, and 127 are deployed to capture video streams. In other embodiments, cameras 125, 126 and 127 can be any other devices that can capture live video streams of one or more objects of interest. When the object of interest moves, it may be captured by different cameras. The object of interest may be presented in video streams captured by different cameras.

In one novel aspect, CDN channels 160 are created. A CDN channel is created for each object in interest. Video streams from multiple cameras will be sent to each corresponding CDN channel according to the object ID and it unique CDN channel. CDN channel 161 is created for object of interest 101 with a unique object ID identified by sensor 111. As object of interest 101 moves, sensor 111 may signal that object of interest switch camera from 126 to camera 127. Similarly, CDN channels 162, 163, 164, and 165 are created for object of interests 102, 103, 104, and 105, respectively. In one embodiment, one or more filler frames are generated for one or more CDN live streams based on real time video streams and a user configuration. For example, filler frames 166 and 167 are inserted in the live stream of 162 and 164, respectively. In one embodiment, the filler frames are inserted upon detecting the object of interest is out of range.

The VPM 150 offers several major functions, namely, (A) activate video cameras in the presence of the objects, (B) identify the objects either by their sensor IDs, or their facial recognition results, (C) send the video stream of the objects of interest to the live video stream through CDN channels 150 (D) communicate the subscriber management module 170 for alerting, rules and other management functions, and (E) archive the video in storage and post process the stored video files for video on demand (VOD) services. In one novel aspect, VPM 150 receives multiple video streams from multiple cameras by a video stream interface 151 and sensor signals by a sensor signal interface 152. VPM 150 distributes video streams in real-time to different CDN channels. A CDN channel live stream module 153 takes input from video stream interface 151 and sensor signal interface 152 and aggregates one or more video streams for each CDN channel. In one embodiment, each CDN channel video streams are saved to video files 154. A postproduction module (PPM) and VOD module 155 further processes the save video files and produces enhanced video files. One or more subscribers can view these enhanced video files. The PPM & VOD 155 offers more fine-tuned and advanced video enhancement process to create professional video summarization and store it in the enhanced Video Database (EVD). For example, the video can be further edited and enhanced, such as shortening uninteresting segments by detecting key frames and zoom/pan for the object of the video. A user/subscriber can view the enhanced summarization through a request to the VOD. A configuration and alert module 158 configures VPM 150 through interface with subscriber management 170 and generates alerts based on rules. Triggering events on objects can be created and maintained in configuration and alert module 170. For example, an object is absent from all video camera streams over a threshold period may trigger a “Object Missing” event that will be broadcast to the relevant parties and stakeholders.

The subscriber management module 170 configures VPM 150 through user command, sends user requests to VPM 150 and sends alerts and other events to the subscribers. A user, such as users 181, 182, 183, 184, 185, and 186 can download and install a mobile APP or a Web application to access the real time CDN Channels 160 or VOD 155 to watch the video stream of the object in interest.

In one scenario, the multi-channel vide stream system is used in kindergarten monitoring. Video recording units, such as cameras are placed in all public areas on campus, such as classrooms, pl playground, corridors, activity rooms and the like. These cameras form a mesh network that essentially cover the entire school. Students will be wearing a badge, watch, bracelet or enroll in a facial recognition system. The badge, watch or bracelet worn by the students can trigger sensor signals. The students can also be enrolled in facial recognition programs to generate the sensor signals. When the system is on, student's movement will trigger the cameras to start streaming to their subscribed CDN channels for the parents. The system further eliminates the need to take attendance. When a student goes inside of the school, the student will be recognized, and attendance will be recorded automatically. Similarly, if a student leaves the school, either in a normal end of the day event or special event that the student is picked up, the event will be also recorded. Alerts will be generated to inform the school and/or the parents upon detecting emergencies or predefined events. Video files are archived for optimization and can be streamed based on user request.

In another scenario, multi-channel video stream system is used to track assets in transit. Assets, cargos, shipments, or any objects that are being transited from place to place can be captured using the system. Each object of asset is assigned a corresponding CDN channel. As the assets moves around, sensor signals are generated and live video streams for each asset is generated. The subscriber can view one or more CDN channels and track the asset. Alerts can be generated upon detecting triggering events such as the asset is out of range. Similarly, retail items can be tracked using the multi-channel video stream system. Another example could be video monitoring on cargo being transported, such as the armor guard transporting the cash box of an ATM whereby the cameras are placed on the ATMs, the body cam and the camera inside the truck. Other use cases such as shipping cargo tracking can also use the system with video streaming via CDN channels.

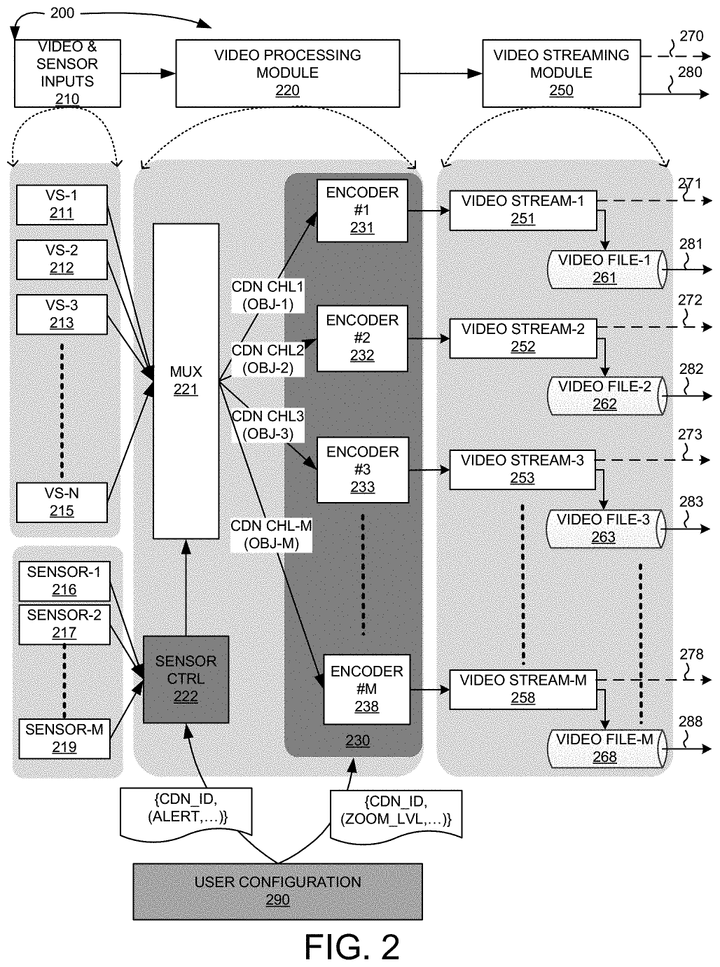

FIG. 2 illustrates exemplary diagrams of a VPM that configures multiple CDN channels and live streams multiple video streams each associated with an object of interest in accordance with embodiments of the current invention. In one novel aspect, multiple CDN channels are created to live stream videos. Each CDN channel carries an output video stream with presence of associated object of interest. A system 200 has a video and sensor inputs 210, a video processing module (VPM) 220, and a video streaming module (VSM) 250, and a user configuration unit 290. Video and sensor inputs 210 captures continuous video streams using video recording units, such as camera. Video and sensor inputs 210 also detects sensor signals such that the live video stream is multiplexed to the corresponding CDN channel. The sensor signals can trigger the camera to be turned on. In one embodiment, the camera is always on the camera itself becomes a sensor that applies facial recognition AI machine learning model to identify the object(s) of interest. VPM 220 processes input live video streams and encodes the live video streams to different CDN channels based on the received sensor signals. The VSM 250 transmits the CDN video streams through corresponding CDN channels. In one embodiment, the video stream in each CDN channel is stored to a corresponding video file. VSM 250 live streams video streams 270 through CDN channels to subscribers. VSM 250 also provides video on demand streams 280. The subscriber can request video streams for one or more object of interests. Video streams 280 are enhanced video streams.

VPM 220 receives inputs from video and sensor input 210 and send source videos to VSM 250 for streaming to corresponding CDN channels. N number of video streams VS-1 211, VS-2 212, VS-3 213, and VS-N 215 are captured by one or more video recording units. VS-1 211, VS-1 211, VS-2 212, VS-3 213, and VS-N 215 are received by a multiplexer MUX 221 of VPM 220. M number of sensor signals sensor-1 216, sensor-2 217, and sensor-M 219 are received by sensor control 222. MUX 221 will get the events from sensor control 222 to generate corresponding video streams for the objects of interest. User configuration unit 290 configures sensor control. The configuration includes configuration for each sensor, configuration for MUX 221 and VPM general configuration. In one embodiment, sensor control 222 receives alert configuration from user configuration 290. In other embodiments, user configuration may directly configure MUX 221. In one embodiment, MUX 221 edits/manipulate video frames based on user request or preconfigured rules. MUX 221 overlays objects, such as text, drawings, and filler frames. MUX 221 sends output video streams to one or more encoders 230, each associate with its CDN channel. M number of encoders encoder#1 231, encoder#2 232, encoder#3 233 and encoder#M 238 receives output video streams from MUX 221. The encoders encode the video as the source for the downstream module VSM 250. In one embodiment, the encoders produce the high quality of video sources. The encoders combine the objects from MUX 221 and the configuration of a specific object of interest to create the source video streams according to the configuration. In one embodiment, the user configuration configures filler frames for one or more CDN channels. The encoder produces the source video for VSM 250 based on the user configurations and fills the configured filler frames upon detecting predefined or preconfigured triggering events. Encoder#1 231 receives CDN channel-1 video stream that is associated with object-1. Similarly, Encoder#2 232 receives CDN channel-2 video stream that is associated with object-2. Encoder#M 238 receives CDN channel-M video stream that is associated with object-M. The encoders send the encoded video streams to output video stream units of VSM 250. In another embodiment, encoders 230 enhance the video stream by zooming in the object. The zoom level is configurable during the object/user setup. Encoders 230, such as encoder#1 231 to encoder#M 238, each generate a source video for a CDN channel associated with an object ID. User configuration unit 290, while configuring each object of interest can configure a zoom level for the object. User configuration 290 sends the encoder configurations, such as zoom level to corresponding encoders. Each encoder may be configured with different zoom level. For example, the zoom level can be set to zoom (crop) at 80%. It masks out other irrelevant objects, etc. It may make the streaming more interesting to the users. The system may set a default zoom level for each object of interest, which is assigned a unique CDN ID. The zoom level can be set dynamically.

VSM 250 handles incoming video stream from VPM 220 and distribute it to the different CDN Channels. Each object in interest will be assigned a unique CDN channel which can view and monitor by a user device. Video stream-1 251 receives source video from encoder#1 231 and transmits the live video stream to CDN channel 271. Similarly, video stream-2 252, video stream-3 253, and video stream-M 258 receive source video from encoder#2 232, encoder#3 233, and encoder#M 238, respectively, and transmits the live video stream to CDN channel 272, 273, and 278, respectively. In one embodiment, enhanced video streams are provided through video on demand channels. Video file storage-1 261 stores live video stream from video stream-1. VSM 250 can transmit the stored video file-1 through video steam 281 upon request from one or more subscribers. In one embodiment, the video file-1 in VSM 250 stores enhanced video files and transmits the enhanced video files through channel 281. Similarly video file-2 262, video file-2 263, and video file-M 268 are saved video stream files from video stream-2 252, video-stream-3, 253, and video stream-M 258, respectively, and can be transmitted to subscribers upon request through channels 282, 283, and 288, respectively.

In one novel aspect, an object of interest is identified in real time in a live video stream among multiple input video streams based on received sensor signals related to the object of interest. One of the important components is the sensor control that generates the sensor signals to correlate the object of interest with the preconfigured CDN channel.

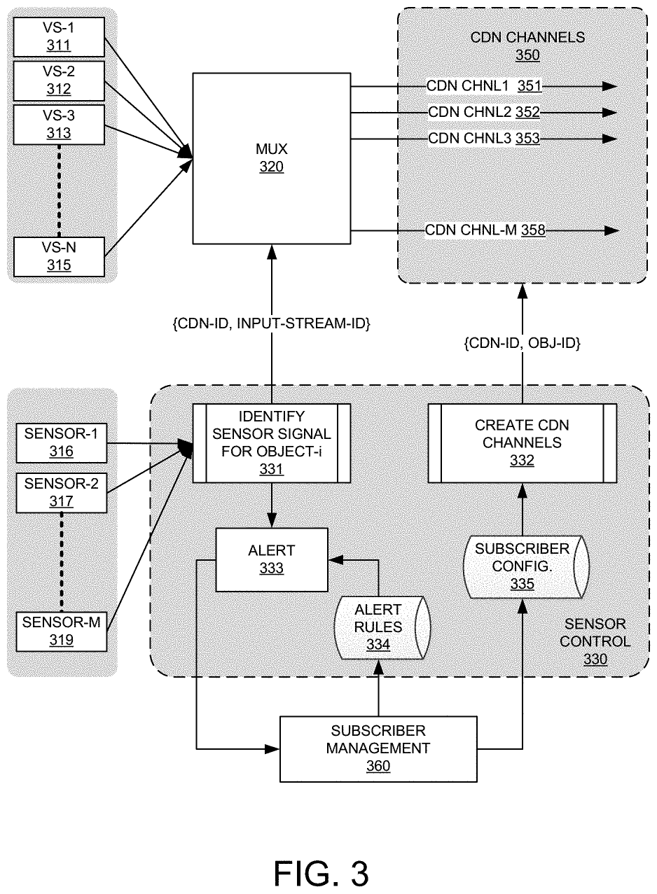

FIG. 3 illustrates exemplary diagrams for a sensor control unit that generates sensor signals for the multiplexer to compile source videos from one or more input live video streams for each CDN channels in accordance with embodiments of the current invention. The Sensor control 330 is the hub of sensor signal streams. Sensor control 330 takes sensor signal inputs from one or more sensors. Sensor control 330 also gets configuration information from subscriber management 300. Sensor control 300 sends sensor signal information to MUX 320 and configures multiple CDN channels for live streaming.

Multiple sensors are deployed to capture sensor signals. A sensor signal can be any type of physical signal, such as IoT signals, RFID, or any other type of electronic or acoustic signals. In another embodiment, the sensor signal can be results of image or facial recognition program. In other embodiments, any identifiable signal of the object of interest, either integrated with the object and being part of the object of interest or being carried, worn, attached, or associated with the object of interest. In a system, the sensor of signals can be a mix of any type of signals. The sensor signals can be configured and dynamically updated. A sensor is registered in the system so that the sensor control only processes solicit units. The sensor also configures the preprocessing pipeline and the individual settings of each sensor.

Sensor control 330 aggregates the signals from different sensors. Sensor signals from sensors 316, 317 and 319 are received at sensor signal identifier 331 of sensor control 330. Sensor signal identifier 331 associates sensor signals each with a object of interest i. Object of interest i is associated with a configured CDN channel i. The signals will be converted to sensor events. The events will be stored in an internal data store to provide tracing information of the object of interest, and to generate feedbacks to the MUX 320 according to the individual settings. The output of sensor signal identifier 331 is sent to MUX 320, which also receives N number of video streams, such as VS-1 311, VS-2 312, VS-3 313, and VS-N 315. The sensor signal outputs, or the feedbacks sends sensor signal events comprises, the camera switch event, target out of range event, timeout event and end of monitoring event. Plug-ins will be developed to accommodate different signal processing logics for different scenarios.

MUX 320 receives multiple video streams and sensor signal events from sensor control 330. MUX 320 produces live video streams for each configured CDN channel 350, such as CDN channel-1 351, CDN channel-2 352, CDN channel-3 353, and CDN channel-M 358. CDN channels 350 is configured by CDN channel configurator 332 based on subscriber configurations stored in subscriber configuration 335. Subscriber management 360 updates configuration information of subscriber configuration 335.

In one embodiment, the system generates alert. The alert unit 333 gets sensor signal events from sensor signal identifier 331 and generates user alerts to subscriber management 360. Alert unit 333 may also generate internal alerts to components of the VPM. The internal alert can trigger internal action. Alert unit 333 generates alert based on alerting rules 334. Alerting rules 334 are configured through subscriber management 360. Alerting rules 334 are stored and can be updated upon receiving updated configuration from subscriber management 360.

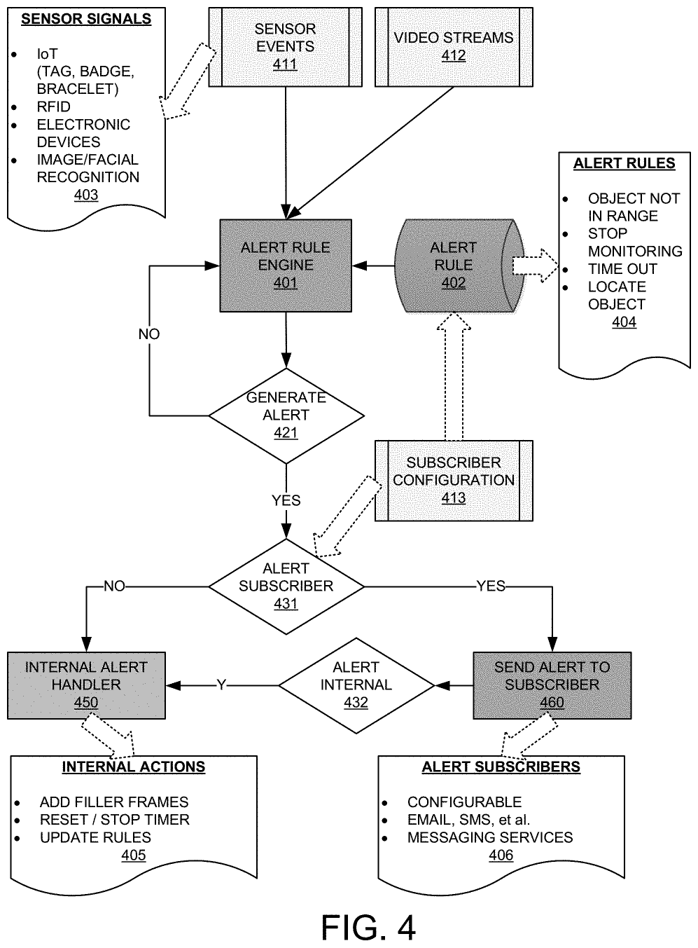

FIG. 4 illustrates exemplary diagrams of the alert system in accordance with embodiments of the current invention. In one embodiment, triggering events on objects of interest can be created and maintain in a database. Alerts, internal and/or external, are generated upon detecting these triggering events. The alert system composes an alert rule interface engine 401, an alert rule store 402, and an alert sender to the subscriber 460 and an internal alert handler 450.

Alert rule interface engine 401 is a runtime/real time engine to execute the rules to decide whether to send an alert. Alert rule interface engine 401 receives sensor events 411 as the input. Exemplary sensor signals 403 can be IoT signals from wearable tag, badge, or bracelet. Sensor signal 403 can also be RFID, or any other electronic, acoustic, or other types signals. In one embodiment, sensor signal 403 can be results of the image/facial recognition program. An inference rule may define additional inputs, such as video streams 412, to make further decision. An inference rule language may define the constructs for sub-rule execution, data retrieval, comparison, and decision output. The engine may allow to execute certain plug-in to fulfill the logics as specified in the rule. An inference rule can be presented in different executable forms including but not limited to: machine or assembly language, intermediate language or byte code, any form of textual presentation (e.g. source code of interpreted languages, XML), any form of trained model and any combinations of the executable mentioned above.

The alert rule store 402 is a data source for serialized rules for execution. The rules can be serialized in different storage types including but not limited to: relational database (RDBMS), non-relational database (NoSQL), file system, and combinations of the storage type mentioned above. Exemplary alert rules 404 includes object of interest not in range, stop monitoring, time out, and object of interest being located. In one embodiment, alert rule 404 is configurable and can be dynamically updated. In another embodiment, different object of interest may be associated with different sets of alert rules. In yet another embodiment, alert rules can be applied to a group of objects of interest. The group rule applies to all member of objects in the group. Individual rules for different object of interest may be mixed with the group rule.

Upon the rule inference engine decision to notify the subscriber, alert sender 460 will pick-up the decision output and send the notification to the subscriber. The alert sender may allow to execute certain plug-in to fulfill the notification request as specified in the decision output. The decision output will specify how to notify the sender based on a subscriber alert configuration 406. Configuration 406 includes but not limited to: Email, SMS, messaging services, and combinations of the communication channel mentioned above. The alert may also be sent internally and be handled via internal alert handler 450 based on internal action configuration 405. Configuration 405 includes but not limited to: adding filler frames, reset or stop timer, and update rules.

Alert rule engine 401 receives sensor events 411. In one embodiment, other inputs, such as video stream 412 are sent to alert rule engine 401. Alert rule engine 401 retrieves alert rules from alert rule store 402. At step 421, alert rule engine 401 determines whether to generate alert based on one or more alert rules. In one embodiment, the alert is generated for one or a group of CDN channels or objects of interests. In other embodiments, the alert is generated for all objects of interest. If step 421 determines no, alert rule engine 401 continues to monitor alert events. If step 421 determines yes, alert rule engine 401 moves to step 431 to determine whether to send the alert to the subscribers. In one embodiment, alert rule engine 401 makes the decision based on rules configured by subscriber configuration 413. Subscriber configuration 413 can also update alert rule store 402 as well. If step 431 determines yes, alert sender 460 sends the alerts to determined subscribers based on configuration 406. Alert rule engine 401, subsequently, determines if the alert is configured to be sent internally at step 432. If step 432 determines yes, internal alert handler takes internal action on the alert based on configuration 405. If step 431 determines no, internal alert handler takes internal action on the alert based on configuration 405.

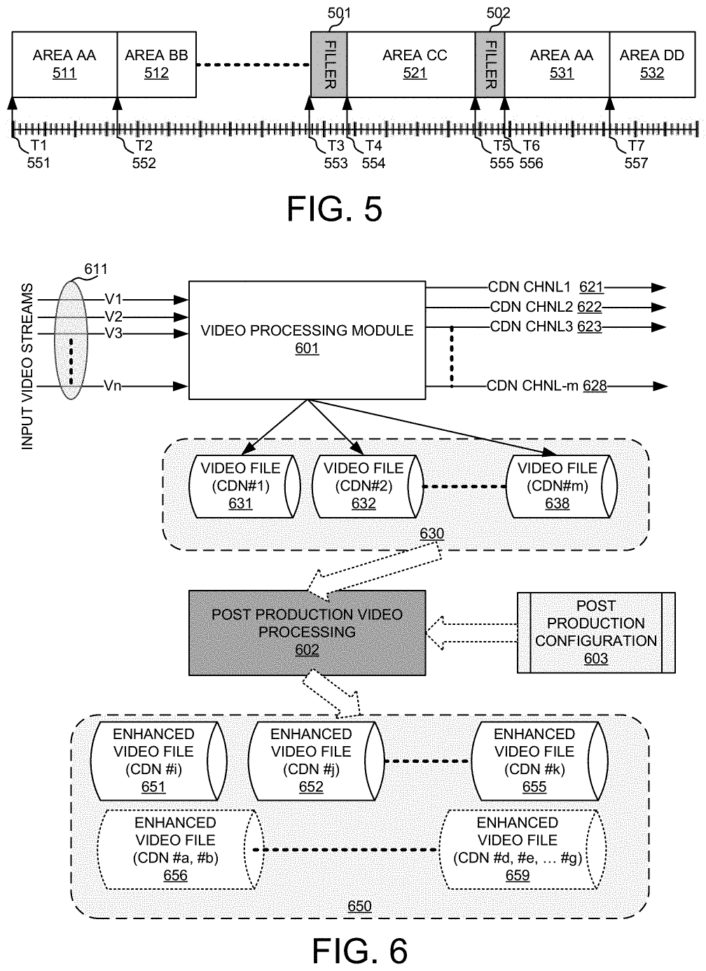

FIG. 5 illustrates an exemplary diagram of a CDN video stream for a monitored object of interest in accordance with embodiments of the current invention. Real time video stream composed of two types of frames, Capture frames and Filler frames. Capture frames are the video frames from the cameras on the object of interest. Depends on the location of the tracking target, capture frames in a video stream may come from different cameras in various locations. On the other hand, since it might not be possible to install cameras in certain areas, there will no signal from the object of interest for certain amount of time. The missing signal event is configurable. When this happens, filler frames will be fed into the video stream to indicate the situation. At time T1 551, the object o of interest enters area AA. A sensor signal is generated upon detecting the entering of the monitored object, which is associated with a CDN channel i. Captured frames 511 are associated with CDN channel i and live streams through the CDN channel i. At time T2 552, a signal is received indicating that the object o of interest enters area BB. Captured frames 512 are associated with CDN channel i and live streams through the CDN channel i. At time T3 553, the sensor control determines that object o of interest is out of range. The sensor control determines the out of range event based on sensor signals it receives and a predefined algorithm. In one embodiment, the out of range alert is configured to be sent both to the subscribers of object o of interest and internally. The out of range alert triggers the VPM to add filler frame 501 at time T3 553. In one embodiment, filler frame 501 is preconfigured. The filler frame can be configured by the system and/or by the subscribers. The filler frame configuration can be based on different factors including the CDN channel, the subscriber specific, time, and or combination of the factors. At time T4 554, a signal is received indicating that the object o of interest enters area CC. Captured frames 521 are associated with CDN channel i and live streams through the CDN channel i. At time T5 555, the sensor control determines that object o of interest is out of range. Filler frame 502 is added at T5 555. At time T4 554, a signal is received indicating that the object o of interest enters area AA. Captured frames 531 are associated with CDN channel i and live streams through the CDN channel i. At time T4 532, a signal is received indicating that the object o of interest enters area DD. Captured frames 532 are associated with CDN channel i and live streams through the CDN channel i.

FIG. 6 illustrates exemplary diagrams for CDN video file postproduction in accordance with embodiments of the current invention. Video processing module 601 receives input live video streams 611 and transmits live streams through CDN channels 621, 622, 623, and 628. The postproduction module 602 is an offline processing unit. Video files 630, such as video files 631, 632, and 638 from Video Processing Module 601 to be queued as a task to create professional video summarization. User can define the post-production template in postproduction configuration 603 to utilize the filters provided in the systems including light equalization, noise reduction, time lapse from a defined event, object tracking such as zoom and pan, and transition. When the task is completed, it will be saved in Enhanced Video Database (EVD) 650 and ready to serve as video on demand (VOD) stream. In one embodiment, EVD 650 has enhanced video files for one CDN channel, such as enhanced video file (CDN #1) 651, enhanced video file (CDN #2) 652, and enhanced video file (CDN #k) 655. In another embodiment, the enhanced video file can be combination of a plurality of CDN channel files, such as enhanced video file (CDN #a, #b) 656, and enhanced video file (CDN #d, #e, . . . #g) 659.

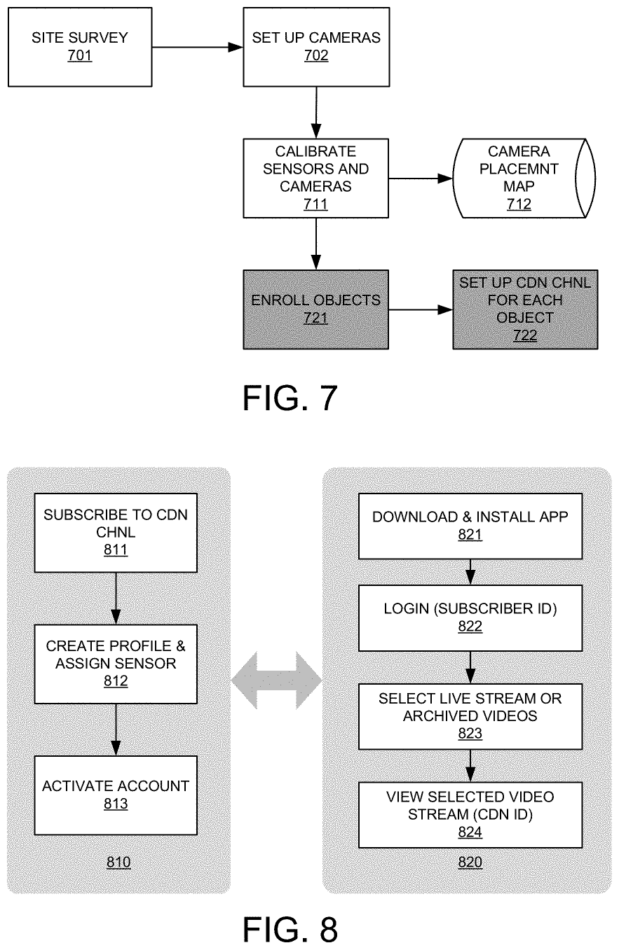

FIG. 7 illustrates an exemplary diagram for system set up for the live streaming through CDN channel in accordance with embodiments of the current invention. System setup and configuration includes setting up the cameras, sensors, and communication modules. At step 701, site survey is conducted. Before setting up the cameras, a site survey shall be conducted in the facility that is going to install the cameras, sensors, and the communication modules. There are several factors affecting the location of the device installation such as power outlet, camera resolution and light sensitivity, lighting, strength of communication modules and sensors, physical obstructions such as walls, posts, pillars and the like, and radio interference. Once the site survey is completed, the video recording units and sensors are set up. At step 702, video recording units such as cameras, and sensors, such as signal receivers, are set up. In one embodiment, different sensors are set up for one coverage area of a camera such that different types of signals can be supported. In another embodiment, new sensors can be added based on the site survey to support updated sensors or new sensors. Based on the results of the site survey, the necessary tools, and facilitations such as camera mount, electricity sockets, cameras, sensor, and communication modules can be installed accordingly. At step 703, calibrations of cameras and sensors are performed. Calibration will be needed to adjust the placement of the sensors/cameras, to fine tune the parameters such as sensitivity/threshold, and eventually to optimize the synchronization of the cameras and sensors. At step 712, camera placement map is generated. The location of the sensors and the camera will be put into a camera placement map. This map will be saved into the system for the monitoring dashboard. At step 721, object enrollment is performed. Each trackable object will be enrolled to the system. The objects can be identified by but not limited to the following items, Wi-Fi, Bluetooth or any wireless signals, color, shape or facial or image recognition. The enrollment can be a self-serviced by the end-user or by an authorized system administrator. Before the object of interest is officially enrolled, an approval workflow process could be applied. At step 722, CDN channels are setup for each object enrolled. When the object of interest is enrolled, a unique channel will be generated by the system. User will be notified with the channel URI and the token to subscribe the channel. For security purpose, users are encouraged to provide two communication methods so that the channel URI and the token can be sent in different methods.

FIG. 8 illustrates exemplary diagrams for subscriber management for the live streaming through CDN channel in accordance with embodiments of the current invention. Subscriber system has a subscriber management system 810 and a subscriber application 820. At step 811, subscriber management 810 subscribes a user/subscriber to one or more CDN channels. Upon receiving the CDN channel information, such as a CDN channel URI and the token, the user may start subscribing the video channel by associating the user ID to the CDN channel ID. At step 812, the subscriber management 810 checks if the user profile exists. If the user is not registered, a user profile will be created for the user. The user may assign different sensors that they are interested to the object of interest. If not, step 812 will create a new user profile and assign sensor and CDN channels to the user. If a new use profile is created, an account activation instruction will be sent to the user. At step 813, the user account is activated. The user shall activate the account (22) before logging in. If the account is not activated for 7 days (or a pre-determined period), the profile will be removed from the system. The user will have to create the user profile when they subscribe with the channel URI and token again. In one embodiment, If the channel is not subscribed by any user for a predefined/preconfigured period, the CDN channel and the corresponding artifacts will be removed from the system. The object of interest needs to be enrolled to the system again.

The subscriber at step 821 downloads and install application for the CDN channel live stream. User may download and install the mobile app any time. At step 822, once the user installed the CDN channel application and activated the account, the user may login to the system and select the subscribed CDN channel for the object of interest. At step 823, the user may select to view the d CDN in live stream or in the archived through VOD. In one embodiment, to achieve better user experience, a CDN will be configured and the CDN will stream the video segments according to the user location. At step 824, the user views the selected video stream on the user device.

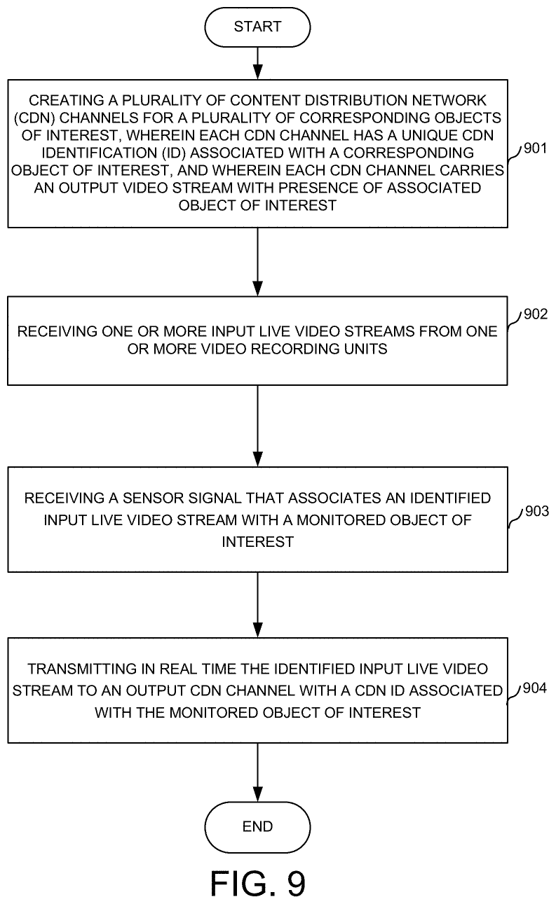

FIG. 9 illustrates an exemplary flow chart for multi-channel video stream in real time in accordance with embodiment of the current invention. At step 901, the video processing system creates a plurality of CDN channels for a plurality of corresponding objects of interest, wherein each CDN channel has a unique CDN identification (ID) associated with a corresponding object of interest, and wherein each CDN channel carries an output video stream with presence of associated object of interest. At step 902, the video processing system receives one or more input live video streams from one or more video recording units. At step 903, the video processing system receives a sensor signal that associates an identified input live video stream with a monitored object of interest. At step 904, the video processing system transmits in real time the identified input live video stream to an output CDN channel with a CDN ID associated with the monitored object of interest.

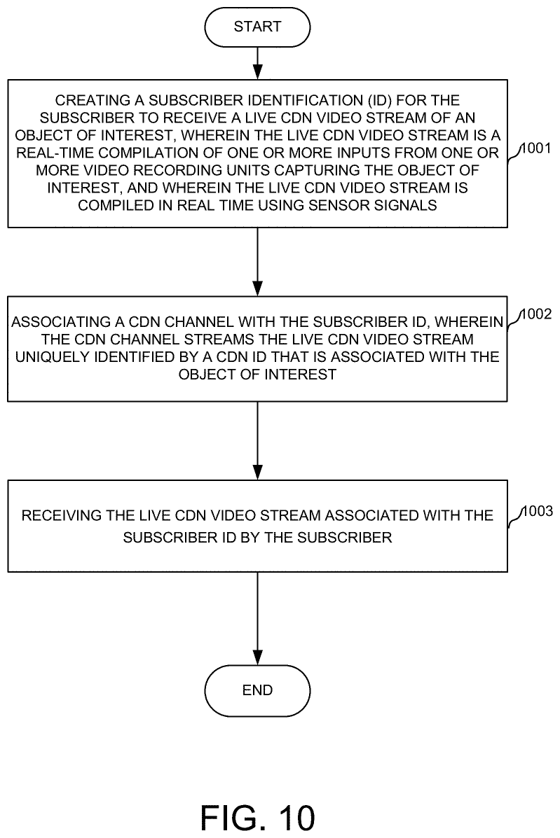

FIG. 10 illustrates an exemplary flow chart for a subscriber of the multi-channel video stream summarization system to subscribe and receives live video streams of object of interest in accordance with embodiments of the current invention. At step 1001, a subscriber identification (ID) is created for the subscriber to receive a live CDN video stream of an object of interest, wherein the live CDN video stream is a real-time compilation of one or more inputs from one or more video recording units capturing the object of interest, and wherein the live CDN video stream is compiled in real time using sensor signals. At step 1002, a CDN channel is associated with the subscriber ID, wherein the CDN channel streams the live CDN video stream uniquely identified by a CDN ID that is associated with the object of interest. At step 1003, the subscriber receives the live CDN video stream associated with the subscriber ID.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method, comprising:
creating a plurality of content distribution network (CDN) channels for a plurality of corresponding objects of interest, wherein each CDN channel has a unique CDN identification (ID) associated with a corresponding object of interest, and wherein each CDN channel carries an output video stream with presence of associated object of interest;
receiving a plurality of input live video streams from a plurality of video recording units;
receiving a sensor signal that associates an identified input live video stream with a monitored object of interest;
transmitting in real time the identified input live video stream to an output CDN channel with a CDN ID associated with the monitored object of interest.

2. The method of claim 1, wherein the sensor signal is sent by a sensor device upon detecting an ID signal from an ID marker attached to the monitored object of interest.

3. The method of claim 1, wherein the sensor signal is based on a result of real-time image or facial recognition identifying the monitored object of interest in the identified input live video stream.

4. The method of claim 1, further comprising: generating an alert for a CDN channel upon detecting one or more alerting triggering events comprising:
a sensor switching event, an object of interest out of range event, a timeout event, and an end of monitoring event.

5. The method of claim 4, further comprising sending the alert to one or more subscribers subscribed to the CDN channel based on predefined alerting rules.

6. The method of claim 1, further comprising adding filler frames to a CDN video stream upon detecting one or more triggering events of the corresponding object of interest.

7. The method of claim 1, further comprising:
archiving the one or more CDN video streams; and
performing postproduction video enhancements on the archived one or more CDN video streams.

8. A system, comprising:
a plurality of video recording units that each captures a live video stream;
a video processing module (VPM) that creates a plurality of content distribution network (CDN) channels for a plurality of corresponding objects of interest, wherein each CDN channel has a unique CDN identification (ID) associated with a corresponding object of interest, and wherein each CDN channel carries an output video stream with presence of associated object of interest, and receives one or more sensor signals that each associates an identified input live video stream with a monitored object of interest; and
a video streaming module (VSM) that transmitting in real time the identified input live video stream to an output CDN channel with a CDN ID associated with the monitored object of interest.

9. The system of claim 8, wherein the sensor signal is sent by a sensor device upon detecting an ID signal from an ID marker attached to the monitored object of interest.

10. The system of claim 8, wherein the sensor signal is based on a result of real-time image or facial recognition identifying the monitored object of interest in the identified input live video stream.

11. The system of claim 8, further comprising: an alert module that generates an alert for a CDN channel upon detecting one or more alerting triggering events comprising a sensor switching event, an object of interest out of range event, a timeout event, and an end of monitoring event.

12. The system of claim 11, wherein the alert module sends the alert to one or more subscribers subscribed to the CDN channel based on predefined alerting rules.

13. The system of claim 8, wherein the VPM adds filler frames to a CDN video stream upon detecting one or more triggering events of the corresponding object of interest.

14. The system of claim 8, further comprising a postproduction module that archives the one or more CDN video streams, and performs postproduction video enhancements on the archived one or more CDN video streams.

15. A method for a subscriber to a content distribution network (CDN), comprising:
creating a subscriber identification (ID) for the subscriber to receive a live CDN video stream of an object of interest, wherein the live CDN video stream is a real-time compilation of a plurality of inputs from one or more video recording units capturing the object of interest, and wherein the live CDN video stream is compiled in real time using sensor signals;
associating a CDN channel with the subscriber ID, wherein the CDN channel streams the live CDN video stream uniquely identified by a CDN ID that is associated with the object of interest; and
receiving the live CDN video stream associated with the subscriber ID by the subscriber.

16. The method of claim 15, wherein the sensor signal is sent by a sensor device upon detecting an ID signal from an ID marker attached to the monitored object of interest.

17. The method of claim 15, wherein the sensor signal is based on a result of real-time image or facial recognition identifying the monitored object of interest in the identified input live video stream.

18. The method of claim 15, wherein the subscriber ID is associated with a plurality of CDN channels, and wherein the subscriber can receive a plurality of corresponding CDN video streams.

19. The method of claim 15, further comprising: receiving an enhanced video recording for the object of interest by the subscriber, wherein the object of interest is identified by the CDN ID.

20. The method of claim 15, further comprising: receiving an alert by the subscriber, wherein the alert is triggered upon detecting triggering events for the corresponding CDN channel.
